(19) United States
(12) Patent Application Publication
(10) Pub. No.: US 2026/0072323 A1
(43) Pub. Date: Mar. 12, 2026

(54) DISPLAY MODULE

(71) Applicant: E Ink Holdings Inc., Hsinchu (TW)

(72) Inventors: Yen-Ze Huang, Hsinchu (TW); Jen-Shiun Huang, Hsinchu (TW); Hsin-Tao Huang, Hsinchu (TW)

(73) Assignee: E Ink Holdings Inc., Hsinchu (TW)

(21) Appl. No.: 19/296,948

(22) Filed: Aug. 12, 2025

(30) Foreign Application Priority Data
Sep. 10, 2024 (TW) 113134197

(51) Int. Cl. G02F 1/1679; G02F 1/167

(52) U.S. Cl. CPC G02F 1/1679; G02F 1/167; G02F 2202/28

(57) ABSTRACT

A display module sequentially including an active layer, a display layer, an isolation layer, a first adhesive layer, at least one light-guiding layer, a second adhesive layer, and at least one light-transmitting layer along a stacking direction is provided. The display module further includes a first frame adhesive structure and a second frame adhesive structure. The first frame adhesive structure is disposed around the first adhesive layer. An adhesion force of the first frame adhesive structure is greater than an adhesion force of the first adhesive layer. The second frame adhesive structure is disposed around the second adhesive layer. An adhesion force of the second frame adhesive structure is greater than an adhesion force of the second adhesive layer.

### CROSS-REFERENCE TO RELATED APPLICATION

This application claims the priority benefit of Taiwan application serial no. 113134197, filed on Sep. 10, 2024. The entirety of the above-mentioned patent application is hereby incorporated by reference herein and made a part of this specification.

### BACKGROUND

### Technical Field

The disclosure relates to a display module, and more particularly, to an electronic paper display module.

### Description of Related Art

An electronic paper display is a new type of display device that is thin and durable, and has low power consumption. The electronic paper display meets requirements for energy saving and environmental protection, and has been widely used in electronic readers (e.g., e-books or electronic newspapers) or other markets for electronic components (e.g., electronic tags).

However, in a stacked structure of a current display module, due to different thermal expansion coefficients of different layer structures, it is prone to issues such as expansion and deformation when heated or material rupture caused by heat. On the other hand, in a multi-layer stacked structure, a curing process of an adhesive material may easily cause the stacked structure to warp. Therefore, how to design a heat-resistant and highly reliable stacked structure is one of development goals in the art.

### SUMMARY

The disclosure provides a display module, which may avoid thermal expansion and deformation, thereby improving overall structural strength.

The disclosure provides a display module, sequentially including an active layer, a display layer, an isolation layer, a first adhesive layer, at least one light-guiding layer, a second adhesive layer, and at least one light-transmitting layer along a stacking direction. The display module further includes a first frame adhesive structure and a second frame adhesive structure. The first frame adhesive structure is disposed around the first adhesive layer, and an adhesion force of the first frame adhesive structure is greater than an adhesion force of the first adhesive layer. The second frame adhesive structure is disposed around the second adhesive layer, and an adhesion force of the second frame adhesive structure is greater than an adhesion force of the second adhesive layer.

In an embodiment of the disclosure, the display module meets at least one of the following conditions: (1) the adhesion force of the first frame adhesive structure is 1.5 times greater than the adhesion force of the first adhesive layer; and (2) the adhesion force of the second frame adhesive structure is 1.5 times greater than the adhesion force of the second adhesive layer.

In an embodiment of the disclosure, the adhesion force of at least one of the first frame adhesive structure and the second frame adhesive structure is greater than 6 kg/inch.

In an embodiment of the disclosure, the adhesion force of at least one of the first adhesive layer and the second adhesive layer is less than 5 kg/inch.

In an embodiment of the disclosure, the first frame adhesive structure and the second frame adhesive structure are substantially the same.

In an embodiment of the disclosure, a width of at least one of the first frame adhesive structure and the second frame adhesive structure is greater than or equal to 1 mm and less than or equal to 3 mm.

In an embodiment of the disclosure, a thickness of at least one of the first frame adhesive structure and the second frame adhesive structure is greater than or equal to 0.5 mm and less than or equal to 2 mm.

In an embodiment of the disclosure, the display module meets at least one of the following conditions: (1) a thickness of the first frame adhesive structure is equal to a thickness of the first adhesive layer; and (2) a thickness of the second frame adhesive structure is equal to a thickness of the second adhesive layer.

In an embodiment of the disclosure, in the stacking direction, the first frame adhesive structure completely overlaps the second frame adhesive structure.

In an embodiment of the disclosure, the display module further includes a third frame adhesive structure disposed around the isolation layer and the display layer to be connected to the isolation layer, the display layer, and the active layer.

In an embodiment of the disclosure, the third frame adhesive structure is further disposed on a top side surface of the active layer.

In an embodiment of the disclosure, a Young's modulus of the third frame adhesive structure is less than 200 megapascals.

In an embodiment of the disclosure, a thermal expansion coefficient of the isolation layer is greater than a thermal expansion coefficient of the active layer.

In an embodiment of the disclosure, a thermal expansion coefficient of the display layer is greater than a thermal expansion coefficient of the active layer.

In an embodiment of the disclosure, a material of the at least one light-guiding layer is plastic.

In an embodiment of the disclosure, a thermal expansion coefficient of the at least one light-guiding layer is 10 times greater than a thermal expansion coefficient of the at least one light-transmitting layer.

In an embodiment of the disclosure, a thermal expansion coefficient of the at least one light-guiding layer is 10 times greater than a thermal expansion coefficient of the active layer.

In an embodiment of the disclosure, a thickness of the at least one light-transmitting layer is greater than a thickness of the at least one light-guiding layer.

In an embodiment of the disclosure, a thickness of the at least one light-guiding layer is greater than a thickness of the active layer.

The disclosure further provides a display module, sequentially including an active layer, a display layer, an isolation layer, a first adhesive layer, at least one light-guiding layer, a second adhesive layer, and at least one light-transmitting layer along a stacking direction. The display module further includes a first frame adhesive structure disposed around the first adhesive layer, a second frame adhesive structure disposed around the second adhesive layer, and a third frame adhesive structure disposed around the isolation layer and the display layer to be connected the isolation layer, the display layer, and the active layer. A Young's modulus of the third frame adhesive structure is less than 100 megapascals.

Based on the above, in the display module of the disclosure, the display module sequentially includes the active layer, the display layer, the isolation layer, the first adhesive layer, the at least one light-guiding layer, the second adhesive layer, and the at least one light-transmitting layer along the stacking direction. In addition, the display module further includes the first frame adhesive structure and the second frame adhesive structure. The first frame adhesive structure is disposed around the first adhesive layer, and the adhesion force of the first frame adhesive structure is greater than the adhesion force of the first adhesive layer. The second frame adhesive structure is disposed around the second adhesive layer, and the adhesion force of the second frame adhesive structure is greater than the adhesion force of the second adhesive layer. In this way, in the large-size display structure, the thermal expansion deformation caused by the large difference in the thermal expansion coefficients between the light-guiding layer and other structures may be avoided, thereby improving the overall structural strength of the display device.

In order for the aforementioned features and advantages of the disclosure to be more comprehensible, embodiments accompanied with drawings are described in detail below.

### BRIEF DESCRIPTION OF THE DRAWINGS

FIG. 1 is a schematic cross-sectional view of a display module according to an embodiment of the disclosure.

FIG. 2 is a schematic cross-sectional view of a display module according to another embodiment of the disclosure.

### DETAILED DESCRIPTION OF DISCLOSED EMBODIMENTS

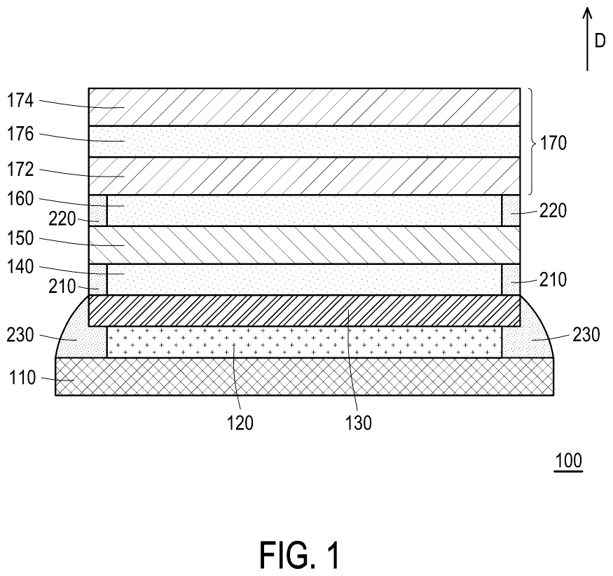

FIG. 1 is a schematic cross-sectional view of a display module according to an embodiment of the disclosure. Referring to FIG. 1, in this embodiment, a display module 100 is provided, such as electronic paper (ePaper) or referred to as an electronic paper module, which may be applied to electronic readers (or referred to as e-books), electronic paper notebooks, interactive whiteboards, electronic identification cards, electronic signage, electronic labels, laptops, monitors, mobile phone accessories, clothing accessories, device electronic appearances, smart wearable devices, etc. used to display an image by using ambient light as a main light source. The display module 100 in this embodiment may be applied in a field of large size, and the large size may be defined as greater than 75 inches.

The display module 100 sequentially includes an active layer 110, a display layer 120, an isolation layer 130, a first adhesive layer 140, at least one light-guiding layer 150, a second adhesive layer 160, and at least one light-transmitting layer 170 along a stacking direction D. The active layer 110 is, for example, a thin-film transistor (TFT) with glass as a substrate, which is electrically connected to the display layer 120 and is used to electrically drive the display layer 120.

The display layer 120 is, for example, electrophoretic ink including multiple microcapsules, which is electrically connected to the active layer 110, and is used to change positions of the microcapsules according to an electrical state of the active layer 110 and display the image by reflecting an ambient light source. The disclosure does not limit a type of the display layer 120. In this embodiment, a thermal expansion coefficient of the display layer 120 is greater than a thermal expansion coefficient of the active layer 110.

The isolation layer 130 is, for example, a water-blocking material, which is used to cover and protect the display layer 120 to prevent water vapor and other external factors from entering. In this embodiment, a thermal expansion coefficient of the isolation layer 130 is greater than the thermal expansion coefficient of the active layer 110.

The light-guiding layer 150 is, for example, a light-guiding plate made of plastic, which is used to guide and homogenize a light beam. In this embodiment, the number of light-guiding layers 150 is, for example, one. However, in different embodiments, the number of light-guiding layers 150 may be designed to be multiple, and a connecting light-transmitting adhesive layer is disposed between the two adjacent light-guiding layers 150. However, the disclosure is not limited thereto. In this embodiment, a thermal expansion coefficient of the light-guiding layer 150 is 10 times greater than the thermal expansion coefficient of the active layer 110. In addition, in this embodiment, a thickness of the light-guiding layer 150 is greater than a thickness of the active layer 110.

The light-transmitting layer 170 is, for example, a protective cover plate made of glass, which is used to cover and protect the light-guiding layer 150 to prevent water vapor and other external factors from entering. The number of light-transmitting structures in the light-transmitting layer 170 may be multiple. For example, in this embodiment, the light-transmitting layer 170 includes a first sub-light-transmitting layer 172, a second sub-light-transmitting layer 174, and a connecting light-transmitting adhesive layer 176 connected between the first sub-light-transmitting layer 172 and the second sub-light-transmitting layer 174. However, in different embodiments, the light-transmitting layer 170 may also be designed as a single protective cover plate, and the disclosure is not limited thereto. In this embodiment, the thermal expansion coefficient of the light-guiding layer 150 is 10 times greater than a thermal expansion coefficient of the light-transmitting layer 170. In addition, in this embodiment, a thickness of the light-transmitting layer 170 is greater than the thickness of the light-guiding layer 150.

The first adhesive layer 140 and the second adhesive layer 160 are, for example, connecting light-transmitting adhesive layers, which are respectively connected between the isolation layer 130 and the light-guiding layer 150 and between the light-guiding layer 150 and the light-transmitting layer 170. At least one of the first adhesive layer 140 and the second adhesive layer 160 has an adhesion force of less than 5 kg/inch. For example, in this embodiment, the adhesion force of the first adhesive layer 140 and the adhesion force of the second adhesive layer 160 are both between 3 and 4 kg/inch.

The display module 100 further includes a first frame adhesive structure 210 and a second frame adhesive structure 220, which are respectively disposed around the first adhesive layer 140 and the second adhesive layer 160. In this embodiment, the first frame adhesive structure 210 and the second frame adhesive structure 220 are substantially the same. A thickness of the first frame adhesive structure 210 is equal to a thickness of the first adhesive layer 140, and a thickness of the second frame adhesive structure 220 is equal to a thickness of the second adhesive layer 160. However, the disclosure is not limited thereto. In the stacking direction D, the first frame adhesive structure 210 completely overlap the second frame adhesive structure 220. In addition, outer edges of the first frame adhesive structure 210 and the second frame adhesive structure 220 may be aligned with edges of upper and lower adjacent structures (i.e., the first sub-light-transmitting layer 172, the light-guiding layer 150, and the isolation layer 130). However, the disclosure is also not limited thereto.

Specifically, in terms of a structural design, a width of the first frame adhesive structure 210 is greater than or equal to 1 mm and less than or equal to 3 mm, and the thickness of the first frame adhesive structure 210 is greater than or equal to 0.5 mm and less than or equal to 2 mm. A width of the second frame adhesive structure 220 is greater than or equal to 1 mm and less than or equal to 3 mm, and the thickness of the second frame adhesive structure 220 is greater than or equal to 0.5 mm and less than or equal to 2 mm. In addition, an adhesion force of the first frame adhesive structure 210 is greater than 6 kg/inch, and is greater than the adhesion force of the first adhesive layer 140. An adhesion force of the second frame adhesive structure 220 is greater than 6 kg/inch, and is greater than the adhesion force of the second adhesive layer 160. For example, in this embodiment, the adhesion force of the first frame adhesive structure 210 is 1.5 times greater than the adhesion force of the first adhesive layer 140, and the adhesion force of the second frame adhesive structure 220 is 1.5 times greater than the adhesion force of the second adhesive layer 160. In this way, in a large-size display structure, thermal expansion deformation caused by a large difference in the thermal expansion coefficients between the light-guiding layer 150 and other structures may be avoided, thereby improving overall structural strength of the display device.

On the other hand, in this embodiment, the display module 100 further includes a third frame adhesive structure 230, which is disposed around the isolation layer 130 and the display layer 120 to be connected to the isolation layer 130, the display layer 120, and the active layer 110. In this embodiment, the third frame adhesive structure 230 is further disposed on a top side surface of the active layer 110. In other words, different from the first frame adhesive structure 210 and the second frame adhesive structure 220, a shape of the third frame adhesive structure 230 extends from a side of the isolation layer 130 to a top surface of the active layer 110, as shown in FIG. 1. In addition, in this embodiment, a Young's modulus of the third frame adhesive structure 230 is less than 200 megapascals. In this way, the isolation layer 130 and the display layer 120 may be prevented from warping due to a smaller thermal expansion coefficient than the active layer 110, thereby improving the overall structural strength of the display device.

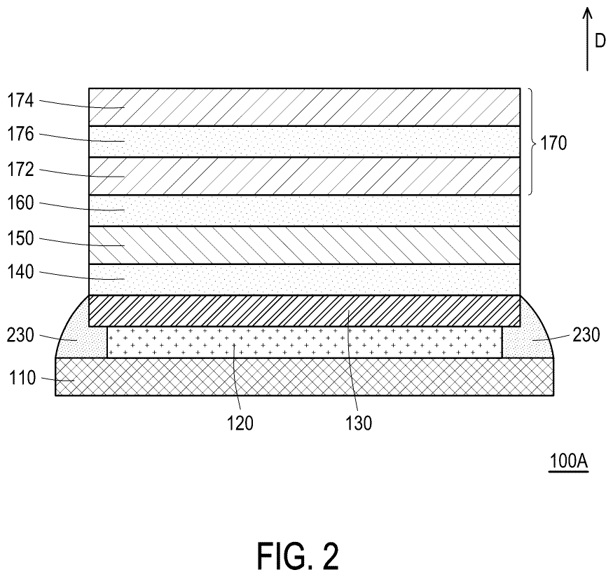

FIG. 2 is a schematic cross-sectional view of a display module according to another embodiment of the disclosure. Referring to FIG. 2, a display module 100A shown in this embodiment is similar to the display module 100 shown in FIG. 1. A difference between the two is that in this embodiment, the display module 100A does not include the first frame adhesive structure 210 and the second frame adhesive structure 220 shown in FIG. 1. Therefore, in this embodiment, it is necessary to use the third frame adhesive structure 230 (or referred to as an anti-warping frame adhesive structure) with a smaller Young's modulus. For example, in this embodiment, the Young's modulus of the third frame adhesive structure 230 is less than 100 megapascals. In this way, the isolation layer 130 and the display layer 120 may be prevented from warping due to a smaller thermal expansion coefficient than the active layer 110, thereby improving the overall structural strength of the display device.

Based on the above, in the display module of the disclosure, the display module sequentially includes the active layer, the display layer, the isolation layer, the first adhesive layer, the at least one light-guiding layer, the second adhesive layer, and the at least one light-transmitting layer along the stacking direction. In addition, the display module further includes the first frame adhesive structure and the second frame adhesive structure. The first frame adhesive structure is disposed around the first adhesive layer, and the adhesion force of the first frame adhesive structure is greater than the adhesion force of the first adhesive layer. The second frame adhesive structure is disposed around the second adhesive layer, and the adhesion force of the second frame adhesive structure is greater than the adhesion force of the second adhesive layer. In this way, in the large-size display structure, the thermal expansion deformation caused by the large difference in the thermal expansion coefficients between the light-guiding layer and other structures may be avoided, thereby improving the overall structural strength of the display device.

Although the disclosure has been described with reference to the above embodiments, they are not intended to limit the disclosure. It will be apparent to one of ordinary skill in the art that modifications to the described embodiments may be made without departing from the spirit and the scope of the disclosure. Accordingly, the scope of the disclosure will be defined by the attached claims and their equivalents and not by the above detailed descriptions.

What is claimed is:

1. A display module, sequentially comprising an active layer, a display layer, an isolation layer, a first adhesive layer, at least one light-guiding layer, a second adhesive layer, and at least one light-transmitting layer along a stacking direction, wherein the display module further comprises:
a first frame adhesive structure disposed around the first adhesive layer, wherein an adhesion force of the first frame adhesive structure is greater than an adhesion force of the first adhesive layer; and
a second frame adhesive structure disposed around the second adhesive layer, wherein an adhesion force of the second frame adhesive structure is greater than an adhesion force of the second adhesive layer.

2. The display module according to claim 1, wherein the display module meets at least one of the following conditions: (1) the adhesion force of the first frame adhesive structure is 1.5 times greater than the adhesion force of the first adhesive layer; and (2) the adhesion force of the second frame adhesive structure is 1.5 times greater than the adhesion force of the second adhesive layer.

3. The display module according to claim 1, wherein the adhesion force of at least one of the first frame adhesive structure and the second frame adhesive structure is greater than 6 kg/inch.

4. The display module according to claim 1, wherein the adhesion force of at least one of the first adhesive layer and the second adhesive layer is less than 5 kg/inch.

5. The display module according to claim 1, wherein the first frame adhesive structure and the second frame adhesive structure are substantially the same.

6. The display module according to claim 1, wherein a width of at least one of the first frame adhesive structure and the second frame adhesive structure is greater than or equal to 1 mm and less than or equal to 3 mm.

7. The display module according to claim 1, wherein a thickness of at least one of the first frame adhesive structure and the second frame adhesive structure is greater than or equal to 0.5 mm and less than or equal to 2 mm.

8. The display module according to claim 1, wherein the display module meets at least one of the following conditions: (1) a thickness of the first frame adhesive structure is equal to a thickness of the first adhesive layer; and (2) a thickness of the second frame adhesive structure is equal to a thickness of the second adhesive layer.

9. The display module according to claim 1, wherein in the stacking direction, the first frame adhesive structure completely overlaps the second frame adhesive structure.

10. The display module according to claim 1, further comprising:
a third frame adhesive structure disposed around the isolation layer and the display layer to be connected to the isolation layer, the display layer, and the active layer.

11. The display module according to claim 10, wherein the third frame adhesive structure is further disposed on a top side surface of the active layer.

12. The display module according to claim 10, wherein a Young's modulus of the third frame adhesive structure is less than 200 megapascals.

13. The display module according to claim 1, wherein a thermal expansion coefficient of the isolation layer is greater than a thermal expansion coefficient of the active layer.

14. The display module according to claim 1, wherein a thermal expansion coefficient of the display layer is greater than a thermal expansion coefficient of the active layer.

15. The display module according to claim 1, wherein a material of the at least one light-guiding layer is plastic.

16. The display module according to claim 1, wherein a thermal expansion coefficient of the at least one light-guiding layer is 10 times greater than a thermal expansion coefficient of the at least one light-transmitting layer.

17. The display module according to claim 1, wherein a thermal expansion coefficient of the at least one light-guiding layer is 10 times greater than a thermal expansion coefficient of the active layer.

18. The display module according to claim 1, wherein a thickness of the at least one light-transmitting layer is greater than a thickness of the at least one light-guiding layer.

19. The display module according to claim 1, wherein a thickness of the at least one light-guiding layer is greater than a thickness of the active layer.

20. A display module, sequentially comprising an active layer, a display layer, an isolation layer, a first adhesive layer, at least one light-guiding layer, a second adhesive layer, and at least one light-transmitting layer along a stacking direction, wherein the display module further comprises:
a first frame adhesive structure disposed around the first adhesive layer;
a second frame adhesive structure disposed around the second adhesive layer; and
a third frame adhesive structure disposed around the isolation layer and the display layer to be connected the isolation layer, the display layer, and the active layer, wherein a Young's modulus of the third frame adhesive structure is less than 100 megapascals.
